(19) United States
(12) Patent Application Publication
(10) Pub. No.: US 2009/0228944 A1
(43) Pub. Date: Sep. 10, 2009

(54) SYSTEM AND METHOD FOR CHAT LOAD MANAGEMENT IN A NETWORK CHAT ENVIRONMENT

(75) Inventor: Maarten P. Bodlaender, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,101

(22) PCT Filed: Apr. 19, 2005
(86) PCT No.: PCT/IB2005/051282

§ 371 Date: Oct. 19, 2006

Related U.S. Application Data
(60) Provisional application No. 60/563,999, filed on Apr. 21, 2004.

(51) Int. Cl. H04N 7/173; G06F 15/16

(52) U.S. Cl. 725/110; 709/206; 709/203

(57) ABSTRACT

A system and method is provided for managing the chat load in a chat room operating in a network chat environment. A chat controller (120) manages a chat room that provides an exchange of information in the form of a plurality of chat lines between a plurality of chat clients registered with the chat room. The chat controller (120) determines a chat associated with the chat room and modifies the chat room based on the chat load.

The present invention is directed, in general, to network chat environment and, more specifically, to a system and method for managing the chat load in a chat room.

Communications networks, such as the Internet or World Wide Web (“Web”), have enabled people throughout the world to exchange information and ideas in real-time. One of the most popular information exchanging forums is called a “chat room.” Chat rooms are provided to members (chat clients) of an on-line service provider to allow multiple chat clients to simultaneously engage in real time text conversations with each other. A chat room is administered by a chat server that receives messages from chat clients and distributes the messages to the chat clients registered with the chat room.

Recently, interactive television systems have been developed that incorporate chat room functionality with broadcast television programming. Interactive television systems are capable of delivering conventional audio and video associated with a television program, along with text, graphic images, web pages and other information to television viewers. Such additional information can include chat lines related to the particular broadcast television program. For example, when a viewer selects a chat option while viewing a particular television program, the viewer can be placed in a chat room corresponding to the television program. Text messages from other viewers of the same television program can be superimposed over the broadcasted television program and displayed to the viewer.

However, chat rooms traditionally include only a limited number of chat clients. As the popularity of interactive television increases, the number of chat clients registered with a chat room related to a particular television program could scale well beyond the capabilities of current chat room environments. In order for chat clients to read a particular chat line, that chat line should be displayed for at least three seconds. With potentially thousands of chat clients, each sending text messages, the wait time for broadcasting and displaying the text messages may become too long, resulting in dissatisfied chat clients and unmanageable chat rooms. For example, if a particular chat client reads a chat line and sends a text message responding to the chat line, the text message may not be displayed for minutes, making chat room conversations difficult to follow.

There is therefore a need in the art for a system and method that is capable of managing the chat load in a chat room.

To address the deficiencies of the prior art mentioned above, the system and method of the present invention is capable of managing the chat load in a chat room. The system and method of the present invention is also capable of automatically dividing or merging chat rooms to manage the chat load. The system and method of the present invention is further capable of managing the chat load, while preserving ongoing chat conversations.

The system and method of the present invention comprises a chat controller in a network chat environment. The chat controller manages an initial chat room that has a set of chat clients registered therewith. The chat clients exchange information in the form of a plurality of chat lines in the initial chat room. The chat controller determines a chat load representing a statistic associated with the chat lines and modifies the initial chat room based on the chat load.

In one advantageous embodiment, the chat controller is capable of measuring the chat load against a threshold to determine whether to divide the initial chat room into multiple chat rooms or merge the initial chat room with one or more additional chat rooms.

In a further embodiment of the present invention, a thread management controller is provided in communication with the chat controller to determine one or more associations between the chat lines and identify one or more threads corresponding to the associations. The chat controller modifies the initial chat room based on the threads.

It is an object of the present invention to provide a system and method for managing the chat load in a chat room.

It is another object of the present invention to provide a system and method: for automatically dividing or merging chat rooms to manage the chat load.

It is also an object of the present invention to provide a system and method for preserving chat conversations while managing the chat load.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the Detailed Description of the Invention, it may be advantageous to set forth definitions of certain words and phrases used throughout this patent document: the terms “include” and “comprise” and derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller,” “processor,” or “apparatus” means any device, system or part thereof that controls at least one operation, such a device may be implemented in hardware, firmware or software, or some combination of at least two of the same. It should be noted that the functionality associated with any particular. controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document. Those of ordinary skill in the art should understand that in many, if not most instances, such definitions apply to prior uses, as well as future uses, of such defined words and phrases.

For a more complete understanding of the present invention, and the advantages thereof, reference is now made to the following descriptions taken in conjunction with the accompanying drawings, wherein like numbers designate like objects, and in which:

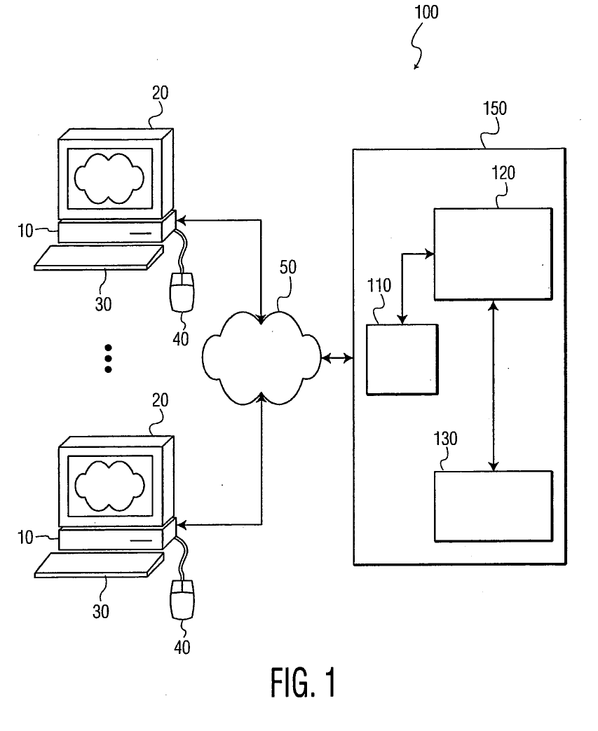

FIG. 1 is a schematic overview of an exemplary system for managing chat load of chat rooms in accordance with the principles of the present invention;

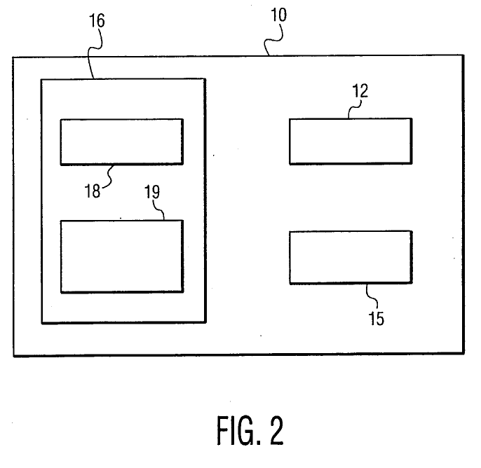

FIG. 2 is a block diagram of an exemplary computer comprising chat capabilities in accordance with the principles of the present invention;

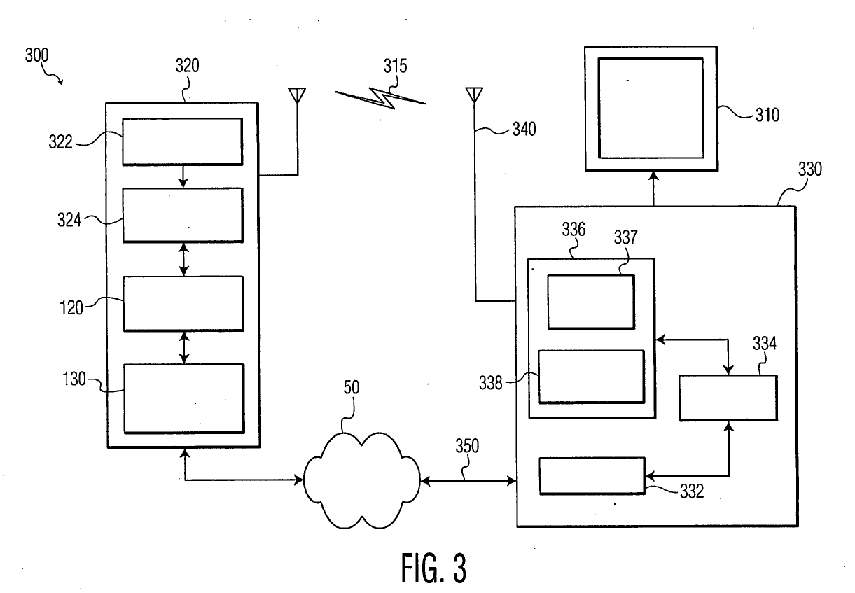

FIG. 3 block diagram of an exemplary interactive television system comprising chat load management capabilities in accordance with the principles of the present invention;

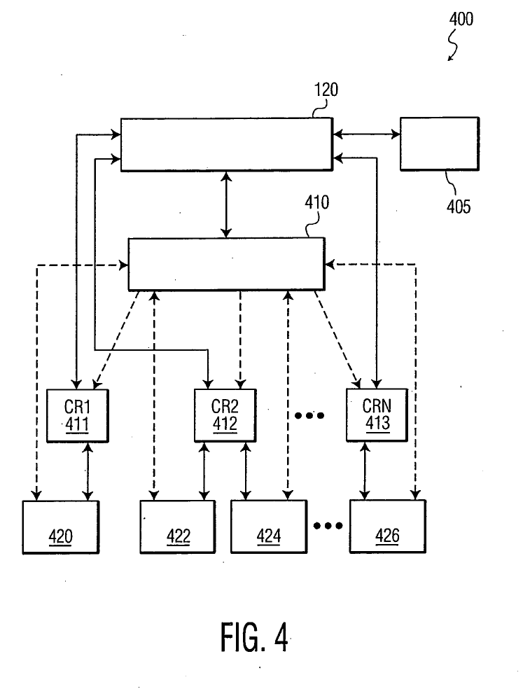

FIG. 4 is a schematic diagram illustrating a system for automatically dividing chat rooms in accordance with an advantageous embodiment of the present invention;

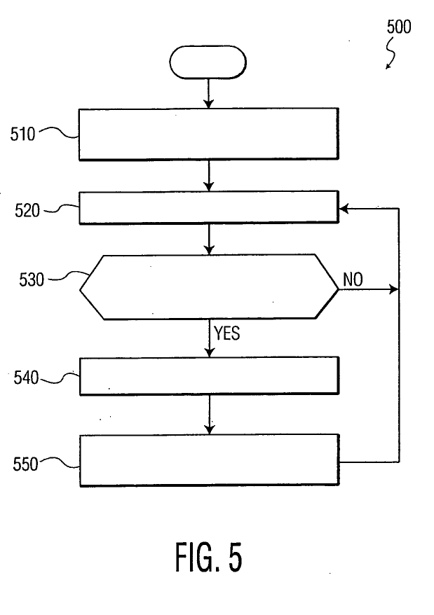

FIG. 5 illustrates a flow chart showing the steps for dividing chat rooms in accordance with the principles of the present invention;

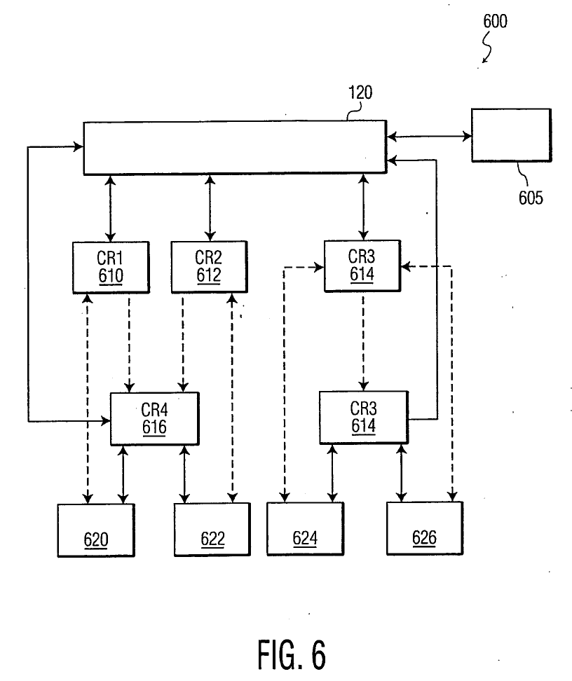

FIG. 6 is a schematic diagram illustrating a system for automatically merging chat rooms in accordance with another advantageous embodiment of the present invention;

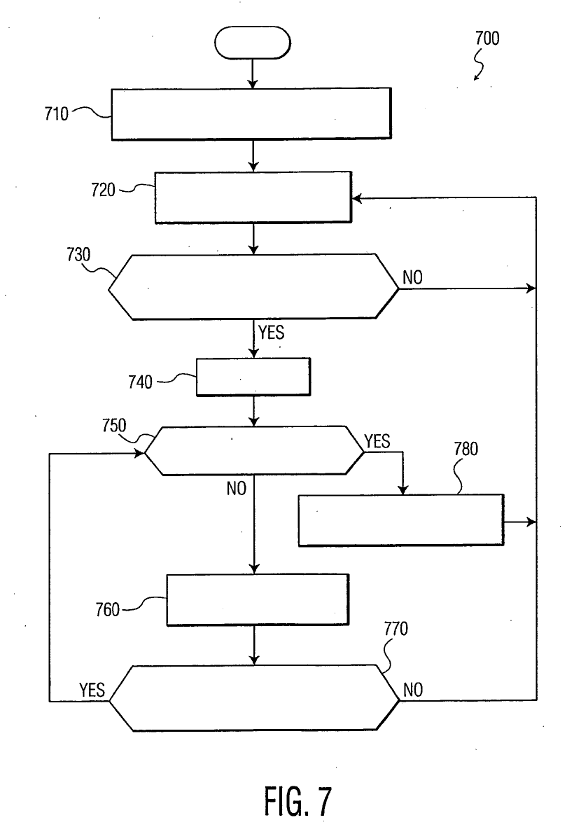

FIG. 7 illustrates a flow chart showing the steps for merging chat rooms in accordance with the principles of the present invention; and

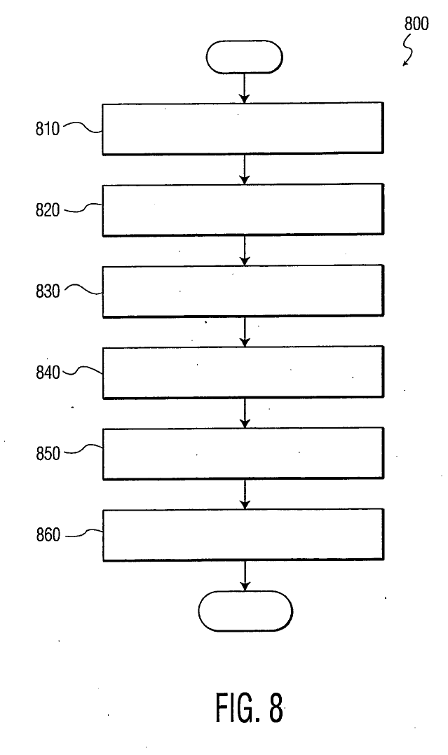

FIG. 8 illustrates a flow chart showing the steps for managing chat rooms using conversation threads in accordance with an advantageous embodiment of the present invention.

FIGS. 1-8, discussed below, and the various embodiments used to describe the principles of the present invention in this patent document are by way of illustration only and should not be construed in any way to limit the scope of the present invention. The present invention may be used in any suitable chat room environment.

FIG. 1 is a schematic overview of an exemplary system 100 for managing chat load in chat rooms in accordance with the principles of the present invention. System 100 includes a distributed computing network 50. In one embodiment, network 50 is the Internet or World Wide Web (“Web”). In other embodiments, network 50 can be a private network or other network capable of transmitting data.

Connected to network 50 are chat server 150 and a plurality of chat terminals 10 associated with chat clients. Each chat terminal 10 comprises a monitor 20 or other type of display device for displaying chat lines to the chat client and one or more input devices 30 and 40 for receiving input (e.g., chat lines) from the chat client. For example, each chat terminal 10 can include a keyboard 30 and mouse 40 to enter chat lines into chat terminal 10 for transmission to chat server 150 via network 50. Other input devices (not shown) may include microphone, joystick, game pad, satellite dish, scanner or the like. In addition, chat terminal 10 may include other peripheral output devices (not shown), such as speakers and printers.

Chat server 150 includes input/output (I/O) unit 110 for transmitting and receiving chat lines to and from chat terminals 10 via network 50. Chat server 150 further includes chat controller 120 for facilitating communication (e.g., chat lines) between chat terminals 10 via network 50 in real time. Chat controller 120 manages one or more chat rooms, each having one or more chat terminals 10 registered therewith. Chat controller 120 receives chat lines from registered chat terminals 10 associated with a particular chat room and retransmits received chat lines to each chat terminal 10 registered with the particular chat room.

In accordance with embodiments of the present invention, chat controller 120 is further capable of managing the chat load in each of the chat rooms controlled by chat controller 120. In one embodiment, chat controller 120 is operable to determine a chat load representing a statistic associated with the chat lines in a particular chat room and modify the particular chat room based on the chat load. For example, as will be described in more detail below in connection with FIGS. 4-7, chat controller 120 is capable of measuring the chat load against a threshold to determine whether to divide the particular chat room into multiple chat rooms or merge the particular chat room with one or more additional chat rooms to balance the chat load across all chat rooms. In one embodiment, chat controller 120 can divide or merge chat rooms based on relations between chat clients. For example, chat controller 120 can examine “buddy” lists established by chat clients and, as a default, keep chat clients together that have each other in their “buddy” lists.

In a further embodiment, chat server 150 also includes thread management controller 130 in communication with chat controller 120. Thread management controller 130 is operable to determine one or more associations between the chat lines in a particular chat room using one or more thread management techniques, which will be described in more detail below, and identify one or more threads corresponding to the associations. As used herein, the term “thread” refers to a set of chat lines in a particular time interval that are related to each other by one or more associations. A particular chat line can be related to zero (new thread) or more previous chat lines. Chat controller 120 is further operable to modify the chat room based on the threads. For example, in one embodiment, thread management controller 130 assigns each of the chat lines to one of the threads and determines the chat clients (chat terminals 10) associated with the chat lines in each of the threads. Chat controller 120 can divide or merge chat rooms based on the threads in each chat room to preserve chat conversations.

Various thread management techniques can be used by thread management controller 130 to identify threads in chat rooms. For example, in one embodiment, thread management controller 130 can determine the probability that a particular chat line relates to a previous chat line. If a chat line is sent within a predefined time interval [a,b], the probability is high that the chat line refers to an immediately preceding chat line, and therefore in the same thread. Outside of the predefined time interval [a,b], the probability is low. The predefined time interval [a,b] can be determined by the typical chat client reaction speed, taking into consideration both the time that a chat client begins to type a response and the time the chat client sends the response.

In another embodiment, thread management controller 130 can use a keyword match technique to structure chat room conversations. For example, if a chat line is sent that contains keywords of a previous chat line, there is a high probability that the chat line is a reaction to the previous chat line or at least in the same thread. In a further embodiment, thread management controller can use a frequent interaction technique to identify threads in a chat room. If two chat clients interact frequently, there is a high probability that two nearby chat lines of these two chat clients are related, and thus in the same thread. For example, if two chat clients have each other in their on-line “buddy list,” there is a high probability that chat lines of these two chat clients are related, and thus in the same thread.

In still a further embodiment, thread management controller 130 can use a same client technique to determine the associations between chat lines in a chat room. With a certain probability, the chat lines transmitted by a particular chat client relate to each other. The probability increases when an earlier chat line is unfinished (broken sentence), contains a spelling error, is very long or indicates a list. In an additional embodiment, thread management controller 130 can use a grammar analysis technique to determine threads in a chat room. For example, thread management controller 130 can identify question-answer pairs between chat lines. In a further additional embodiment, thread management controller 130 can use a “popular” chat client filter technique to determine which thread(s) a particular chat line belongs to. For example, thread management controller 130 can track “popular” chat clients that elicit numerous non-negative reactions and can splice the chat lines of a “popular” chat client into one or more threads or one or more chat rooms to keep the chat conversation lively. Any reactions to the spliced-in chat lines can be made visible to the “popular” chat client, regardless of which thread or chat room the “popular” chat client is assigned to.

In still a further additional embodiment, thread management controller 130 can use a filter technique to determine which thread a particular chat line belongs to. For example, if a thread is filtered from a particular chat client, such that the particular chat client does not see the chat lines of the thread, there is a high probability that a chat line transmitted by the particular chat client is not associated with that thread. In still a further additional embodiment, thread management controller 130 can use an identification technique to determine the association between chat lines. Chat clients can explicitly refer to a previous chat line in their chat line. For example, a chat client can click using mouse 40 on a previous chat line before sending their chat line, or a chat client can refer to a previous chat line by a chat line identifier. As an example, a single letter can be provided next to each chat line, and the letters can be reused as chat lines scroll up. As another example, thread names can be assigned by chat clients or thread management controller 130. It should be understood that the thread management techniques described herein are merely illustrative of the many types of techniques that can be used. Thus, the present invention is not limited, to the thread management techniques mentioned above.

FIG. 2 is a block diagram of an exemplary computer 10 comprising chat capabilities in accordance with the principles of the present invention. Computer 10 corresponds to chat terminal in FIG. 1. Computer 10 includes a processor 15, memory 16 and I/O Unit 12. I/O Unit 12 transmits and receives chat lines to and from network 50 (shown in FIG. 1). Processor 15 can be any microprocessor, microcontroller or programmable processing device. Memory 16 can be any type of computer readable media, including but not limited to random access memory (RAM), read only memory (ROM), flash memory, EEPROM, disk drive (e.g., hard disk drive, magnetic disk drive or optical disk drive), floppy disk, tape drive, CDROM, DVD or any other type of storage device. Memory 16 provides. non-volatile storage of computer readable instructions, data structures and other data for computer 10. For example, memory 16 can store web browser 18 and chat application 19. Web browser 18 is run by processor 15 to access network 50. Chat application 19 is run by. processor 15 and manages connectivity and message delivery between computer 10 and chat server 150 (shown in FIG. 1).

In other embodiments, memory 16 could also store a thread management application (not shown) that is capable of providing additional local filtering based on threads to deal with temporary spikes in chat load. For example, if in a given time period, only I chat line can be shown, and there is more than one chat line in the queue, the local thread management application could filter the chat lines that are associated with a non-active thread (i.e., within a thread that the chat client has not recently submitted a chat line).

FIG. 3 is block diagram of an exemplary interactive television system 300 comprising chat load management capabilities in accordance with the principles of the present invention. Interactive television system 300 includes broadcast server 320, such as a digital video broadcasting network server, that broadcasts a broadcast signal 315 to communication devices 305 (only one of which is shown, for simplicity). Broadcast signal 315 can include, for example, interactive television signals comprised of an audio/video portion of a television program 322 and an interactive portion including chat lines associated with a chat room pertaining to the television program.

Broadcast server 320 includes transceiver 324 for transmitting broadcast signal 315 to communication device 305. Broadcast server 320 further includes chat controller 120 for facilitating communication (e.g., chat lines) between communication devices 305 in real time. Chat controller 120 manages one or more chat rooms associated with television program 322, each having one or more communications devices 305 registered therewith. Chat controller 120 receives chat lines from registered communications devices 305 associated with a particular chat room and provides chat lines to transceiver 324 for broadcast with television program 322 over broadcast signal 315 to each communications device 305 registered with the particular chat room. Chat controller 120 further managing the chat load in each of the chat rooms controlled by chat controller 120, as described above in connection with FIG. 1.

Broadcast server 320 also includes thread management controller 130 in communication with chat controller 120. Thread management controller 328 is operable to determine one or more associations between the chat lines in a particular chat room using one or more thread management techniques, as described above, and identify one or more threads corresponding to the associations. Chat controller 120 is further operable to modify the chat rooms based on the associated threads.

Communication device 305 typically includes a receiver 330, such as a set-top box, connected to an antenna 340, a display 310, such as a monitor or television set, and a back channel interface 350 to broadcast server 320 via network 50. Receiver 330 may be integrated into display 310 or be a stand-alone device, such as a set-top box. Receiver 330 comprises transceiver 332, processor 334 and memory 337. Transceiver 332 is operable to transmit chat lines to broadcast server 320 over back channel interface 350 and receive broadcast signal 315 from broadcast server 320 via antenna 340. Processor 334 can be any microprocessor, microcontroller or programmable processing device. Memory 336 can be any type of computer readable media, including but not limited to random access memory (RAM), read only memory (ROM), flash memory, EEPROM, disk drive (e.g., hard disk drive, magnetic disk drive or optical disk drive), floppy disk, tape drive, CDROM, DVD or any other type of storage device.

Memory 336 provides non-volatile storage of computer readable instructions, data structures and other data for computer 10. For example, memory 336 can store web browser 337 and chat application 338. Processor 334 runs chat application 338 to separate the interactive portion of the signal from the AN portion of the signal. Processor 334 runs web 5 browser 337 to establish back channel interface 350 to broadcast server 320 via network 50 to register with a chat room. Processor 334 further runs chat application 338 and web browser 337 to construct a display signal that integrates the AN portion and the interactive portion of the broadcast signal in a suitable format, as requested by the chat client, and to provide the display signal to display 310 for display thereon.

In other embodiments, memory 336 could also store a thread management application (not shown) that is capable of providing additional local filtering based on threads. For example, all chat lines can be broadcast in broadcast signal 315 and the filtering can be done at the receiver 330. As another example, two signals can be broadcast to receiver 330. The normal broadcast signal 315 can include a few non-personalized chat lines relevant to the topic 15 associated with the chat room that the chat client is currently registered, and a second signal (not shown) can include the personalized (filtered) chat lines associated with the chat room that the chat client is currently registered with. Receiver 330 can replace part of the broadcasted, non-personalized chat lines with the personalized chat lines to enable the chat client to view the personalized chat lines and other relevant chat lines.

FIG. 4 is schematic diagram illustrating a system for automatically dividing chat rooms in accordance with an advantageous embodiment of the present invention. FIG. 4 illustrates a chat room environment 400 where communication is sent within a chat room 410 between a set of chat clients 420, 422, 424 and 426 through chat controller 120 that manages chat room 410. Chat clients 420, 422, 424 and 426 correspond to chat terminals 10 of FIG. 1, communication devices 305 of FIG. 3 or any other user device capable of registering with chat room 410 and sending and receiving chat lines in chat room 410.

In FIG. 4, chat controller 120 is operable to calculate the chat load in chat room 410, where the chat load represents a statistic associated with the chat lines transmitted in chat room 410. For example, the statistic can be the average number of chat lines per second sent by chat clients 420, 422, 424 and 426 in chat room 410. However, it should be understood that any statistic capable of measuring the chat load in a chat room can be used. Chat controller 120 is further operable to compare the calculated chat load with a high threshold (THIGH) 405. If the calculated chat load exceeds THIGH 405, chat controller 120 is operable to create new chat rooms 411, 412 and 413. The set of chat clients 420, 422, 424 and 426 are divided over new chat rooms 411, 412 and 413, such that the chat load in each of new chat rooms 411, 412 and 413 does not exceed THIGH 405. For example, as shown in FIG. 4, chat client #1 420 is moved from chat room 410 into new chat room (CR1) 411, chat client #2 424 and chat client #3 424 are moved from chat room 410 into new chat room (CR2) 412 and chat client #N 426 is moved from chat room 410 into new chat room (CRN) 413. It should be understood that the number of new chat rooms 411, 412 and 413 can be one or greater, with a portion of chat clients 420, 422, 424 and 426 being moved from chat room 410 to the new chat room(s). It should further be understood that the assignment of chat clients to new chat rooms can be performed based on conversation threads in the chat room.

FIG. 5 illustrates a flow chart showing the steps for dividing chat rooms in accordance with the principles of the present invention. The steps shown in FIG. 5 are collectively referred to with reference numeral 500. At step 510, a chat room is established with a set of registered chat clients. At step 520, the chat load in the chat room is determined and compared with a threshold at step 530. If the chat load is less than the threshold, the chat load in the chat room is determined again at step 520. However, if the chat load in the chat room exceeds the threshold, one or more new chat rooms are created at step 540 and the set of registered chat clients is divided over the chat rooms at step 550.

FIG. 6 is a schematic diagram illustrating a system for automatically merging chat rooms in accordance with another advantageous embodiment of the present invention. FIG. 6 illustrates a chat room environment 600 where communication is sent within multiples chat rooms 610, 612 and 614 between respective sets of chat clients 620, 622, 624 and 626 through chat controller 120 that manages chat rooms 610, 612 and 614. For example, chat client #1 620 is registered with chat room (CR1) 610, chat client #2 622 is registered with chat room (CR2) 612 and chat clients #3 and #4 624 and 626, respectively, are registered with chat room (CR3) 614. Chat clients 620, 622, 624 and 626 correspond to chat terminals 10 of FIG. 1, communication devices 305 of FIG. 3 or any other user device capable of registering with chat room 410 and sending and receiving chat lines in chat rooms 610, 612 and 614.

In FIG. 6, chat controller 120 is operable to calculate the respective chat load in each chat room 610, 612 and 614, where the chat load represents a statistic associated with the chat lines transmitted in each chat room 610, 612 and 614. For example, with respect to CR3 614, the statistic can be the average number of chat lines per second sent by chat clients 624 and 626 in CR3 614. Chat controller 120 is further operable to compare the calculated chat load in each chat room 610, 612 and 614 with a low threshold (TLOW) 605. If the calculated chat load in any chat room 610, 612 or 614 falls below TLOW 605, chat controller 120 is operable to merge the low chat room(s) with one or more additional chat rooms, such that the chat load in each chat room is above TLOW 605. For example, as shown in FIG. 6, the chat load in either one or both of chat rooms CR1 610 and CR2 612 falls below TLOW 605, and chat controller 120 merges chat rooms CR1 610 and CR2 612 into chat room CR4 616 and chat clients #1 and #2 620 and 622 are moved into CR4 616. The chat load in CR4 is now above TLOW 605. The chat load in chat room CR3 614 is above TLOW 605. Therefore, CR3 614 is not combined with any other chat rooms, and chat clients #3 and #4 624 and 626, respectively, remain registered with CR3 614.

In other embodiments, chat clients registered with a low chat room (e.g., CR1 610) can be distributed over multiple chat rooms (e.g., CR2 612 and CR3 614). In further embodiments, chat clients from CR2 612 and/or CR3 614 can be moved over to the low chat room CR1 to balance the load in all chat rooms 610, 612 and 614. It should be understood that the number of chat rooms 610, 612 and 614 merged and/or modified can be two or greater in any possible load balancing configuration. It should further be understood that chat clients from a low chat room can be merged with chat clients from one or more additional chat rooms based on conversation threads in the chat rooms.

FIG. 7 illustrates a flow chart showing the steps for merging chat rooms in accordance with the principles of the present invention. The steps shown in FIG. 7 are collectively referred to with reference numeral 700. At step 710, chat rooms are established with respective sets of registered chat clients. At step 720, the chat load in each chat room is determined and compared with a threshold at step 730. If the chat load in all chat rooms is greater than the threshold, the chat load in each chat room is determined again at step 720. However, if the chat load in any of the chat rooms falls below the threshold, a timer is set at step 740. At step 750, a determination is made whether the timer has expired. If not, the chat load in the low chat room is determined at step 760 and compared against the threshold at step 770. If the chat load increases above the threshold before the timer expires, the chat load in each chat room is once again determined at step 720. However, if the chat load remains below the threshold for the duration of the timer, the low chat room is merged with one or more additional chat rooms or one or more chat clients or chat lines of one or more chat rooms at step 780.

FIG. 8 illustrates a flow chart showing the steps for managing chat rooms using conversation threads in accordance with an advantageous embodiment of the present invention. The steps shown in FIG. 8 are collectively referred to with reference numeral 800. At step 810, a plurality of chat lines are received from registered. chat terminals associated with one or more chat rooms. At step 820, one or more associations between the chat lines per chat room are determined using one or more thread management techniques, as described above. From the determined associations, one or more threads per chat room are identified at step 830, and each of the chat lines is assigned to one of the threads at step 840. At step 850, the chat clients are associated with the threads based on the chat line assignments performed in step 840. At step 860, the chat rooms are merged or divided based on the threads. For example, each thread in a particular chat room can be assigned to one of two or more new chat rooms. As another example, related or similar threads in different chat rooms can be merged together.

While the present invention has been described in detail with respect to certain embodiments thereof, those skilled in the art should understand that they can make various changes, substitutions, modifications, alterations and adaptations in the present invention without departing from the concept and scope of the invention in its broadest form.

1. A system for chat load management in a network chat environment, comprising:
an initial chat room having a set of chat clients registered therewith, the chat clients exchanging information in the form of chat lines therebetween; and
a chat controller (120) operable to manage said initial chat room, said chat controller (120) being further operable. to determine a chat load representing a statistic associated with the chat lines and modify said initial chat room based on the chat load.

2. The system of claim 1, further comprising:
a chat server (150) connected via a distributed computing network 50 to the set of chat clients, said chat controller (120) being implemented on said chat server 150.

3. The system of claim 1, wherein said network chat environment comprises an interactive television system (300), said initial chat room being related to a television program (322), and further comprising:
a broadcast server (320) operable to broadcast the television program (322), said chat controller (120) being implemented on said broadcast server (320); and
a receiver (330) associated with one of the chat clients, said receiver (330) being operable to receive the television program (322) and the chat lines, said receiver (330) being further operable to display the television program (322) and the chat lines on a display device (310).

4. The system of claim 1, wherein the statistic is an average number of the chat lines per second and further comprising a threshold for measuring against the chat load.

5. The system of claim 4, wherein the threshold is a high threshold (405), said chat controller (120) being further operable to divide said initial chat room (410) into at least two additional chat rooms (411, 412) when the chat load exceeds the high threshold (405).

6. The system of claim 5, wherein the expected chat load in each of the additional chat rooms (411, 412) is below the high threshold (405).

7. The system of claim 4, wherein the threshold is a low threshold (605), said chat controller (120) being further operable to merge said initial chat room (610) with chat lines from an additional chat room (612) when the chat load falls below the low threshold (605).

8. The system of claim 7, further comprising a timer, said chat controller (120) being operable to set said timer when the chat load falls below the low threshold (605), said chat controller (120) being further operable to merge said initial chat room (610) with the chat lines from the additional chat room (612) when the chat load remains below the low threshold (605) at the expiration of the timer.

9. The system of claim 7, wherein said chat controller (120) is operable to move the set of chat clients to the additional chat room (612).

10. The system of claim 7, wherein said chat controller (120) is operable to distribute the set of chat clients (620,622) across at least one additional chat room (616).

11. The system of claim 10, wherein the chat load in each of the at least one additional chat room (616) is above the low threshold (605).

12. The system of claim 7, wherein said chat controller (120) is operable to move chat clients (622) associated with at least one additional chat room (612) into said initial chat room (610).

13. The system of claim 12, wherein the chat load in said initial chat room (610) is above the low threshold (605).

14. The system of claim 1, further comprising:
a thread management controller(130) in communication with said chat controller (120), said thread management controller(130) being operable to determine one or more associations between the chat lines and identify one or more threads corresponding to the one or more associations, said chat controller (120) being operable to modify said initial chat room based on the one or more threads.

15. The system of claim 14, wherein said thread management controller (130) is further operable to associate each of the chat clients with one of the threads and divide the set of chat clients across one or more additional chat rooms based on the threads.

16. A method for managing the chat load in a network chat environment, comprising:
establishing an initial chat room with a set of registered chat clients to enable the chat clients to exchange information therebetween in the form of chat lines;
determining a chat load representing a statistic associated with the chat lines; and
modifying the initial chat room based on the chat load.

17. The method of claim 16, further comprising:
connecting the set of registered chat clients via a distributed computing network 50.

18. The method of claim 16, wherein said network chat environment comprises an interactive television system (300), said initial chat room being related to a television program (322), and further comprising:
transmitting the television program (322) and the chat lines to each of the chat clients.

19. The method of claim 16, wherein said determining further comprises:
calculating an average number of the chat lines per second to determine the chat load; and
measuring a threshold against the chat load.

20. The method of claim 19, wherein the threshold is a high threshold (405), said modifying further comprising:
dividing the initial chat room (410) into at least two additional chat rooms (411, 412) when the chat load exceeds the high threshold (405).

21. The method of claim 19, wherein the threshold is a low threshold (605), said modifying further comprising:
merging the initial chat room (610) with chat lines from at least one additional chat room (612) when the chat load falls below the low threshold (605).

22. The method of claim 21, wherein said merging further comprises:
setting a timer when the chat load falls below the low threshold (605); and
merging the initial chat room (610) with the chat lines from the at least one additional chat room (612) when the chat load remains below the low threshold (605) at the expiration of the timer.

23. The method of claim 21, wherein said merging further comprises:
distributing the set of chat clients (620,622) across the at least one additional chat room (616).

24. The method of claim 21, wherein said merging further comprises:
moving chat clients (622) associated with the at least one additional chat room (612) into the initial chat room (610).

25. The method of claim 16, wherein said modifying further comprises:
determining one or more associations between the chat lines;
identifying one or more threads corresponding to the one or more associations; and
modifying the initial chat room based on the one or more threads.

26. The method of claim 25, wherein said modifying further comprises:
associating each of the chat clients with one of the threads; and
dividing the set of chat clients across one or more additional chat rooms based on the threads.

27. A computer readable medium containing computer executable instructions to perform a method for managing the chat load in a network chat environment, the method comprising:
establishing an initial chat room with a set of registered chat clients to enable the chat clients to exchange information therebetween in the form of chat lines;
determining a chat load representing a statistic associated with the chat lines; and
modifying the initial chat room based on the chat load.

28. A computer programmed to execute a process for managing the chat load in a network chat environment, the process comprising:
establishing an initial chat room with a set of registered chat clients to enable the chat clients to exchange information therebetween in the form of chat lines;
determining a chat load representing a statistic associated with the chat lines; and
modifying the initial chat room based on the chat-load.
